(19) United States
(12) Patent Application Publication
(10) Pub. No.: US 2005/0213595 A1
(43) Pub. Date: Sep. 29, 2005

(54) Limited cyclical redundancy checksum (CRC) modification to support cut-through routing

(76) Inventor: Takeshi Shimizu, Sunnyvale, CA (US)

Correspondence Address: BAKER BOTTS L.L.P., 2001 ROSS AVENUE, SUITE 600, DALLAS, TX, 75201-2980, US

(21) Appl. No.: 10/808,031

(22) Filed: Mar. 23, 2004

(51) Int. Cl. H04L 12/54

(52) U.S. Cl. 370/428; 370/244

(57) ABSTRACT

A method for error detection in a high-speed switching environment includes receiving, at a switch input port, a plurality of packets, including a first packet having at least first and second portions. The method further includes initiating switching of the first portion before the entire second portion is received at the switch port. An error detection technique may be performed on the first packet using tag data associated with the first packet. In accordance with a particular embodiment of the present invention, switching of the first portion is accomplished in accordance with a cut-through forwarding technique. In accordance with yet another embodiment, the error detection technique is accomplished according to a limited cyclical redundancy checksum technique.

### TECHNICAL FIELD OF THE INVENTION

This invention relates generally to communication systems and more particularly to a system and method for employing limited Cyclical Redundancy Checksum (CRC) modification to support cut-through routing.

### BACKGROUND OF THE INVENTION

High-speed serial interconnects have become more common in communications environments, and, as a result, the role that switches play in these environments has become more important. Traditional switches do not provide the scalability and switching speed typically needed to support these interconnects.

### SUMMARY OF THE INVENTION

Particular embodiments of the present invention may reduce or eliminate disadvantages and problems traditionally associated with switching packets in a high-speed switching environment.

In one embodiment of the present invention, a method for error detection in a high-speed switching environment includes receiving, at a switch input port, a plurality of packets, including a first packet having at least first and second portions. The method further includes initiating switching of the first portion before the entire second portion is received at the switch port. An error detection technique may be performed on the first packet using tag data associated with the first packet. In accordance with a particular embodiment of the present invention, switching of the first portion is accomplished in accordance with a cut-through forwarding technique. In accordance with yet another embodiment, the error detection technique is accomplished using a limited cyclical redundancy checksum technique.

Particular embodiments of the present invention provide one or more advantages. Particular embodiments reduce memory requirements associated with multicast traffic. In particular embodiments, port modules share memory resources, which tends to eliminate head-of-line blocking, reduce memory requirements, and enable more efficient handling of changes in load conditions at port modules. Particular embodiments provide cut-through forwarding, which provides one or more advantages over store-and-forward techniques. Particular embodiments provide delayed cut-through forwarding, which also provides one or more advantages over store-and-forward techniques. Particular embodiments increase the throughput of a switch core. Particular embodiments increase the speed at which packets are switched by a switch core. Particular embodiments employ an error detection technique(s). In accordance with a particular embodiment, the error detection technique is accomplished using a limited cyclical redundancy checksum technique. Particular embodiments reduce the fall-through latency of a switch core, which is important for cluster applications. Particular embodiments are embodied in a single integrated circuit (IC), or chip. Particular embodiments reduce the power dissipation of a switch core. Particular embodiments can be used in different applications, such as Ethernet switches, INFINIBAND switches, 3GIO switches, HYPERTRANSPORT switches, RAPID IO switches, or proprietary backplane switches.

Certain embodiments provide all, some, or none of these technical advantages, and certain embodiments provide one or more other technical advantages readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example system area network;

FIG. 2 illustrates an example switch of a system area network;

FIG. 3 illustrates an example architecture for switching packets in a high speed switching environment;

FIG. 4 illustrates an example switch core of a switch;

FIG. 5 illustrates an example stream memory of a switch core logically divided into blocks; and

FIG. 6 illustrates an example method for error detection in a high speed switching environment that employs cut-through forwarding.

### DESCRIPTION OF EXAMPLE EMBODIMENTS

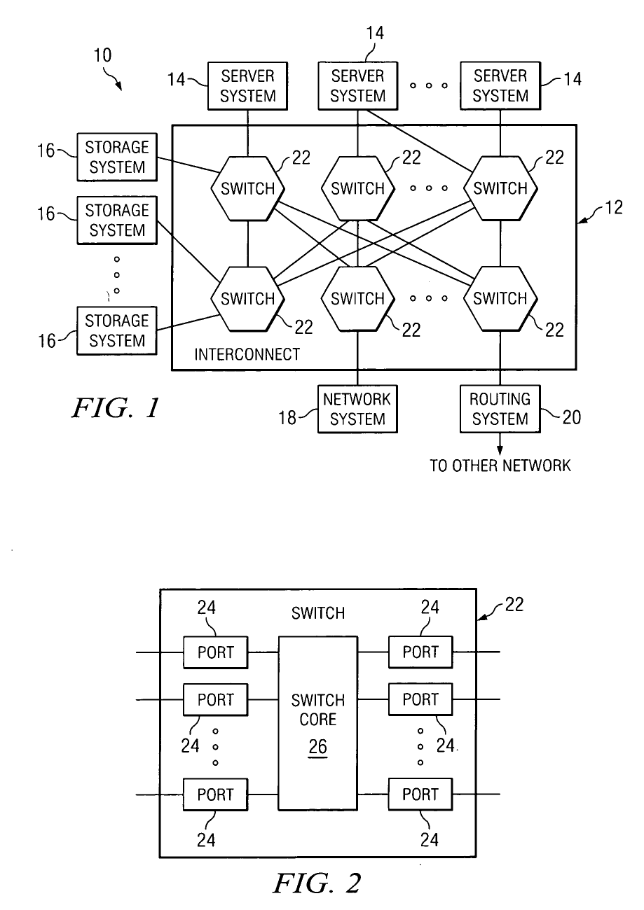

FIG. 1 illustrates an example system area network 10 that includes a serial or other interconnect 12 supporting communication among one or more server systems 14; one or more storage systems 16; one or more network systems 18; and one or more routing systems 20 coupling interconnect 12 to one or more other networks, which include one or more local area networks (LANs), wide area networks (WANs), or other networks. Server systems 14 each include one or more central processing units (CPUs) and one or more memory units. Storage systems 16 each include one or more channel adaptors (CAs), one or more disk adaptors (DAs), and one or more CPU modules (CMs). Interconnect 12 includes one or more switches 22, which, in particular embodiments, include Ethernet switches, as described more fully below. The components of system area network 10 are coupled to each other using one or more links, each of which includes one or more computer buses, local area networks (LANs), metropolitan area networks (MANs), wide area networks (WANs), portions of the Internet, or other wireline, optical, wireless, or other links. Although system area network 10 is described and illustrated as including particular components coupled to each other in a particular configuration, the present invention contemplates any suitable system area network including any suitable components coupled to each other in any suitable configuration.

FIG. 2 illustrates an example switch 22 of system area network 10. Switch 22 includes multiple ports 24 and a switch core 26. Ports 24 are each coupled to switch core 26 and a component of system area network 10 (such as a server system 14, a storage system 16, a network system 18, a routing system 20, or another switch 22). A first port 24 receives a packet from a first component of system area network 10 and communicates the packet to switch core 26 for switching to a second port 24, which communicates the packet to a second component of system area network 10. Reference to a packet can include a packet, datagram, frame, or other unit of data, where appropriate. Switch core 26 receives a packet from a first port 24 and switches the packet to one or more second ports 24, as described more fully below. In particular embodiments, switch 22 includes an Ethernet switch. In particular embodiments, switch 22 can switch packets at or near wire speed.

In accordance with a particular embodiment of the present invention, switch 22 is configured to accommodate cut-through forwarding. Accordingly, switching of any particular packet may begin before the entire packet is received at switch 22. Error detection of this and other embodiments may employ a limited redundancy checksum modification to support cut-through routing. The limited redundancy checksum modification may use changes in a tag for the packet to calculate the CRC.

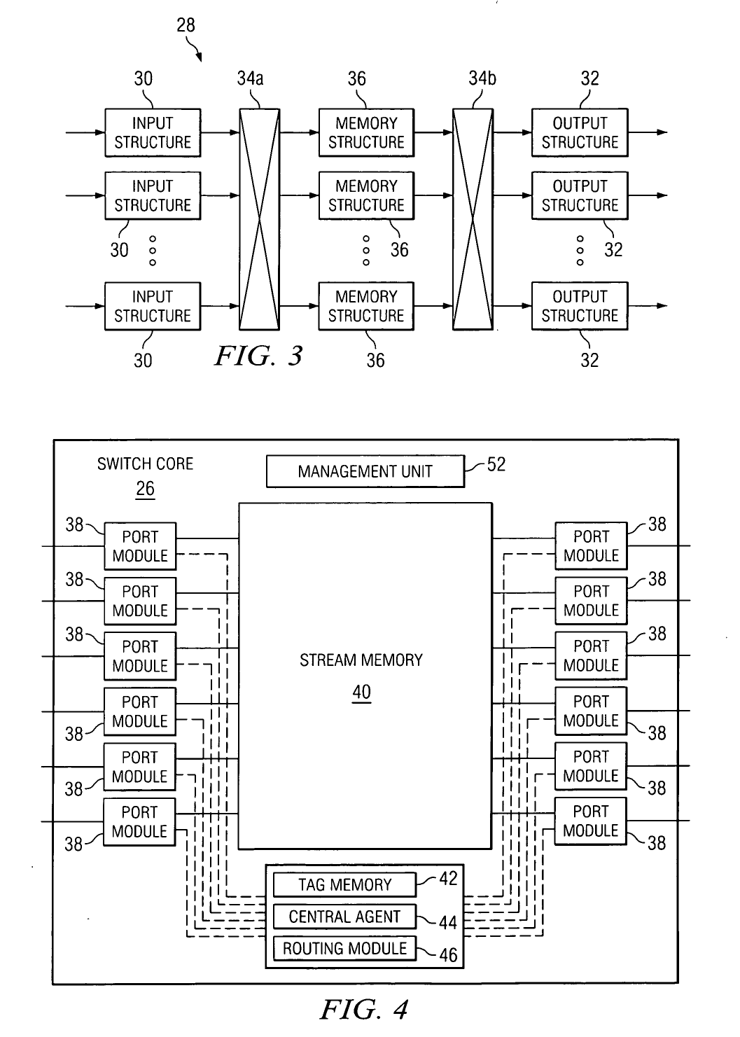

FIG. 3 illustrates an example architecture 28 for switching packets in a high-speed switching environment. Architecture 28 can handle one direction of traffic. Architecture 28 includes one or more input structures 30, one or more output structures 32, two switching structures 34, and one or more memory structures 36. The components of architecture 28 are coupled to each other using buses or other links. In particular embodiments, architecture 28 is embodied in a single IC. Reference to traffic includes one or more packets entering, making their way through, and exiting architecture 28, and reference to a direction of traffic includes a relationship between input structures 30 and output structures 32 according to which packets enter architecture 28 via input structures 30 and exit architecture 28 via output structures 32. Architecture 28 can be used in different applications. As an example and not by way of limitation, architecture 28 can be used in a switch core 26 of an Ethernet switch 22 (which includes a gigabit Ethernet switch 22 in particular embodiments); a switch core 26 of an INFINIBAND switch 22; a switch core 26 of a 3GIO switch 22; a switch core 26 of a HYPERTRANSPORT switch 22; a switch core 26 of a RAPID IO switch 22; or a switch core 26 of a proprietary backplane switch 22 including one or more storage systems 16, network systems 18, or both.

An input structure 30 provides an interface between switch core 26 and a port 24 of switch 22 and includes input logic for receiving a packet from port 24 and writing the packet to one or more memory structures 36 via switching structure 34a. Input structure 30 is coupled to port 24 and switching structure 34a using one or more links. An output structure 32 also provides an interface between switch core 26 and a port 24, but includes output logic for reading a packet from one or more memory structures 36 via switching structure 34b and communicating the packet to port 24. Output structure 32 is coupled to port 24 and switching structure 34b using one or more links. A packet received by an input structure 30 from a first component of system area network 10 is written to one or more memory structures 36 from input structure and later read from memory structures 36 to one or more output structures 32 for communication from output structures 32 to one or more second components of system area network 10.

Reference to a packet being received by an input structure 30 or communicated from an output structure 32 includes the entire packet being received or communicated or only a portion of the packet being received or communicated, where appropriate. Similarly, reference to a packet being written to or read from one or more memory structures 36 includes the entire packet being written to or read from memory structures 36 or only a portion of the packet being written to or read from memory structures 36, where appropriate. As described more fully below, in particular embodiments, an input structure 30 can be combined with an output structure 32 such that a single port module 38 (which is described below) embodying input structure 30 and output structure 32 includes both input logic and output logic. As an alternative, in particular embodiments, port module 38 includes only input logic or only output logic.

Switching structure 34a receives a packet from an input structure 30 and switches the packet to one or more memory structures 36. Write operations via switching structure 34a are scheduled according to a scheduling technique. As an example, in particular embodiments, static scheduling is used for write operations via switching structure 34a. As described more fully below, switching structure 34a includes one or more components for switching packets between input structures 30 and memory structures 36. Switching structure 34b receives a packet from a memory structure 36 and switches the packet to one or more output structures 32. Read operations via switching structure 34b are scheduled according to a scheduling technique. As an example, in particular embodiments, on-demand scheduling is used for read operations via switching structure 34b. On-demand scheduling can include a “connect and release” technique.

As described more fully below, switching structure 34b includes one or more components for switching packets between output structures 32 and memory structures 36. In particular embodiments, switching structure 34a can be combined with switching structure 34b such that a single configuration of components for switching packets between input structures 30 and memory structures 36 and between memory structures 36 and output structures 32 embodies both switching structure 34a and switching structure 34b. In these embodiments, one or more components of the combination can be shared by switching structure 34a and switching structure 34b, but need not be shared by switching structure 34a and switching structure 34b. As an alternative, in particular embodiments, switching structure 34a can be embodied in a configuration of components for switching packets between input structures 30 and memory structures 36 that is separate from a configuration of components for switching packets between memory structures 36 and output structures 32 in which switching structure 34b is embodied. Similarly, switching structure 34b can be embodied in a configuration of components for switching packets between memory structures 36 and output structures 32 that is separate from a configuration of components for switching packets between input structures 30 and memory structures 36 in which switching structure 34a is embodied.

A packet received by switch core 26 is written to one or more memory structures 36 and subsequently read from memory structures 36 for communication out of switch core 26. A memory structure 36 is coupled to switching structure 34a for write operations using one or more links. Memory structure 36 is also coupled to switching structure 34b for read operations using one or more links. As an example, in particular embodiments, memory structure 36 is coupled to switching structure 34a using one link and coupled to switching structure 34b using four links, allowing one write operation to memory structure 36 per write cycle (which includes a series of one or more clock cycles of switch core 26 in which one or more packets are written to a memory structure 36) and four read operations from memory structure 36 per read cycle (which includes a series of one or more clock cycles of switch core 26 in which one or more packets are read from a memory structure 36). Memory structure 36 includes one or more components to and from which data can be written and read. As an example, in particular embodiments, memory structure 36 includes one or more static random access memory (SRAM) devices.

In particular embodiments, any input structure 30 can write to any memory structure 36, and any output structure 32 can read from any memory structure 36. This sharing of memory structures 36 by input structures 30 and output structures 32 eliminates head-of-line blocking (thereby increasing the throughput of switch core 26), reduces memory requirements associated witch switch core 26, and enables switch core 26 to more efficiently handle changes in load conditions at input structures 30, output structures 32, or both. In particular embodiments, a portion of a packet received by switch core 26 from a first component of system area network 10 can be communicated from switch core 26 to one or more second components of system area network 10 before switch core 26 receives the entire packet. In particular embodiments, this cut-through forwarding provides one or more advantages (such as reduced latency, reduced memory requirements, and increased throughput) over “store-and-forward” techniques.

In particular embodiments, switch core 26 includes only one architecture 28 for handling only one direction of traffic. As an alternative, in particular embodiments, switch core 26 includes two architectures 28 for handling two directions of traffic. In these embodiments, one or more components of architectures 28 can be combined with each other. As an example, input structures 30 can be combined with output structures 32 and embodied in port modules 38 that include both input logic and output logic, as described above. As another example, switching structure 34a can be combined with input structure 34b such that a single configuration of components for switching packets between input structures 30 and memory structures 36 and between memory structures 36 and output structures 32 embodies both switching structure 34a and switching structure 34b.

Although input structures 30 are described as being combined with output structures 32 and switching structure 34a is described as being combined with switching structure 34b, the present invention contemplates any suitable combination of any suitable components of architectures 28 in any suitable configuration. As an example, in an embodiment in which two architectures 28 are combined with each other for handling two directions of traffic, one or more port modules 38 of switch core can include only input logic or only output logic. In addition, switching structure 34a can be embodied in a configuration of components that is separate from a configuration of components in which switching structure 34b is embodied, and vice versa.

FIG. 4 illustrates an example switch core 26 of switch 22. Switch core 26 includes twelve port modules 38, stream memory 40, tag memory 42, central agent 44, and routing module 46. The components of switch core 26 are coupled to each other using buses or other links. In particular embodiments, switch core 26 is embodied in a single IC. In a default or other mode of switch core 26, a portion of a packet received by switch core 26 from a first component of system area network 10 can be communicated from switch core 26 to one or more second components of system area network 10 before switch core 26 receives the entire packet. In particular embodiments, cut-through forwarding provides one or more advantages (such as reduced latency, reduced memory requirements, and increased throughput) over store-and-forward techniques. Switch core 26 can be configured for different applications. As an example and not by way of limitation, switch core 26 can be configured for an Ethernet switch 22 (which includes a gigabit Ethernet switch 22 in particular embodiments); an INFINIBAND switch 22; a 3GIO switch 22; a HYPERTRANSPORT switch 22; a RAPID IO switch 22; a proprietary backplane switch 22 for storage systems 16, network systems 18, or both; or other switch 22.

A port module 38 provides an interface between switch core 26 and a port 24 of switch 22. Port module 38 is coupled to port 24, stream memory 40, and tag memory 42. In particular embodiments, port module 38 includes both input logic (which is used for receiving a packet from a component of system area network 10 and writing the packet to stream memory 40) and output logic (which is used for reading a packet from stream memory 40 and communicating the packet to a component of system area network 10). As an alternative, in particular embodiments, port module 38 includes only input logic or only output logic. Reference to a port module 38 can include a port module 38 that includes input logic, output logic, or both, where appropriate. Port module 38 can also include an input buffer for inbound flow control. In particular embodiments, the link coupling port module 38 to stream memory 40 includes two links: one for write operations (which include operations of switch core 26 in which data is written from a port module 38 to stream memory 40) and one for read operations (which include operations of switch core 26 in which data is read from stream memory 40 to a port module 38). Each of these links can carry thirty-six bits, making the data path between port module 38 and stream memory 40 thirty-six bits wide in both directions.

A packet received by a first port module 38 from a first component of system area network 10 is written to stream memory 40 from first port module 38 and later read from stream memory 40 to one or more second port modules 38 for communication from second port modules 38 to one or more second components of system area network 10. Reference to a packet being received by or communicated from a port module 38 can include the entire packet being received by or communicated from port module 38 or only a portion of the packet being received by or communicated from port module 38, where appropriate. Similarly, reference to a packet being written to or read from stream memory 40 can include the entire packet being written to or read from stream memory 40 or only a portion of the packet being written to or read from stream memory 40, where appropriate. Any port module 38 that includes input logic can write to stream memory 40, and any port module 38 that includes output logic can read from stream memory 40. In particular embodiments, the sharing of stream memory 40 by port modules 38 eliminates head-of-line blocking (thereby increasing the throughput of switch core 26), reduces memory requirements associated with switch core 26, and enables switch core 26 to more efficiently handle changes in load conditions at port modules 38.

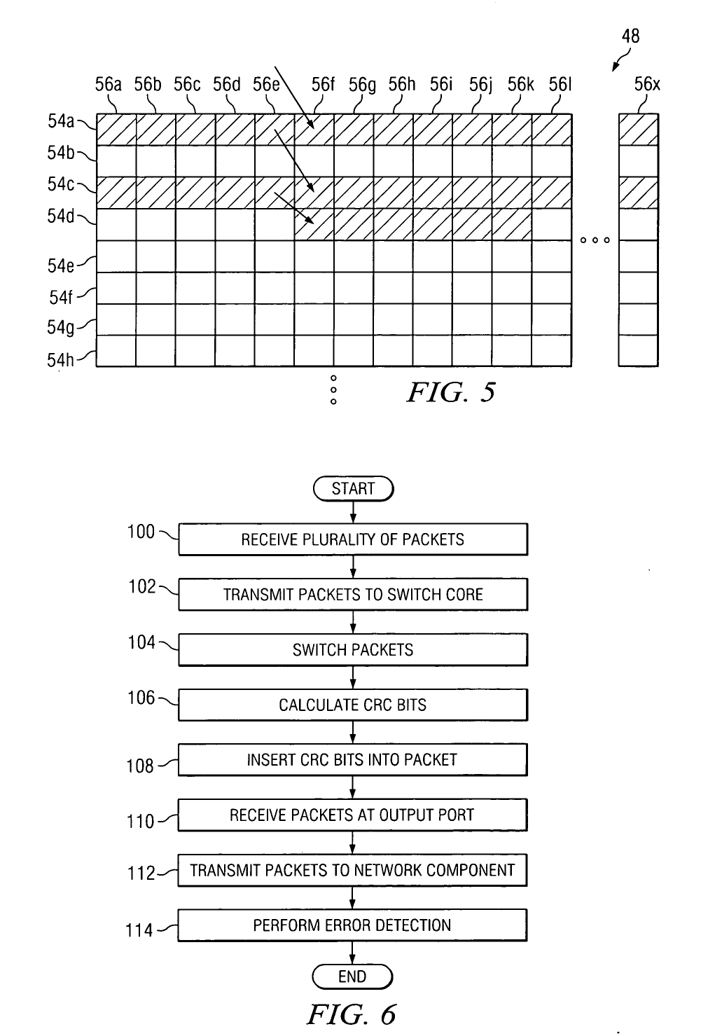

Stream memory 40 of switch core 26 is logically divided into blocks 54, which are further divided into words 56, as illustrated in FIG. 5. A row represents a block 54, and the intersection of the row with a column represents a word 56 of block 54. In particular embodiments, stream memory 40 is divided into 1536 blocks 54, each block 54 includes twenty-four words 56, and a word 56 includes seventy-two bits. Although stream memory 40 is described and illustrated as being divided into a particular number of blocks 54 that are divided into a particular number of words 56 including a particular number of bits, the present invention contemplates stream memory 40 being divided into any suitable number of blocks 54 that are divided into any suitable number of words 56 including any suitable number of bits. Packet size can vary from packet to packet. A packet that includes as many bits as or fewer bits than a block 54 can be written to one block 54, and a packet that includes more bits than a block 54 can be written to more than one block 54, which need not be contiguous with each other.

When writing to or reading from a block 54, a port module 38 can start at any word 56 of block 54 and write to or read from words 56 of block 54 sequentially. Port module 38 can also wrap around to a first word 56 of block 54 as it writes to or reads from block 54. A block 54 has an address that can be used to identify block 54 in a write operation or a read operation, and an offset can be used to identify a word 56 of block 54 in a write operation or a read operation. As an example, consider a packet that is 4176 bits long. The packet has been written to fifty-eight words 56, starting at word 56f of block 54a and continuing to word 56k of block 54d, excluding block 54b. In the write operation, word 56f of block 54a is identified by a first address and a first offset, word 56f of block 54c is identified by a second address and a second offset, and word 56f of block 54d is identified by a third address and a third offset. The packet can also be read from stream memory 40 starting at word 56f of block 54a and continuing to word 56k of block 54d, excluding block 54b. In the read operation, word 56f of block 54a can be identified by the first address and the first offset, word 56f of block 54c can be identified by the second address and the second offset, and word 56f of block 54d can be identified by the third address and the third offset.

Tag memory 42 includes multiple linked lists that can each be used by a first port module 38 to determine a next block 54 to which to write and by one or more second port modules 38 to determine a next block 54 from which to read. Tag memory 42 also includes a linked list that can be used by central agent 44 to determine a next block 54 that can be made available to a port module 38 for a write operation from port module 38 to stream memory 40, as described more fully below. Tag memory 42 includes multiple entries, at least some of which each correspond to a block 54 of stream memory 40. Each block 54 of stream memory 40 has a corresponding entry in tag memory 42. An entry in tag memory 42 can include a pointer to another entry in tag memory 42, resulting in a linked list.

Entries in tag memory 42 corresponding to blocks 54 that are available to a port module 38 for write operations from port module 38 to stream memory 40 can be linked together such that port module 38 can determine a next block 54 to which to write using the linked entries. As an example, consider four blocks 54 that are available to port module 38 for write operations from port module 38 to stream memory 40. A first entry in tag memory 42 corresponding to a first block 54 includes a pointer to a second block 54, a second entry in tag memory 42 corresponding to second block 54 includes a pointer to a third block 54, and a third entry in tag memory 42 corresponding to third block 54 includes a pointer to a fourth block 54. Port module 38 writes to first block 54 and, while port module 38 is writing to first block 54, uses the pointer in the first entry to determine a next block 54 to which to write. The pointer refers port module 38 to second block 54, and, when port module 38 has finished writing to first block 54, port module 38 writes to second block 54. While port module 38 is writing to second block 54, port module 38 uses the pointer in the second entry to determine a next block 54 to which to write. The pointer refers port module 38 to third block 54, and, when port module 38 has finished writing to second block 54, port module 38 writes to third block 54. While port module 38 is writing to third block 54, port module 38 uses the pointer in the third entry to determine a next block 54 to which to write. The pointer refers port module 38 to fourth block 54, and, when port module 38 has finished writing to third block 54, port module 38 writes to fourth block 54. A linked list in tag memory 42 cannot be used by more than one port module 38 to determine a next block 54 to which to write.

When a block 54 is made available to a port module 38 for write operations from port module 38 to stream memory 40, an entry in tag memory 42 corresponding to block 54 can be added to the linked list that port module 38 is using to determine a next block 54 to which to write. As an example, consider the linked list described above. If the fourth entry is the last element of the linked list, when a fifth block 54 is made available to port module 38, the fourth entry can be modified to include a pointer to fifth block 54.

A linked list in tag memory 42 that a first port module 38 is using to determine a next block 54 to which to write can also be used by one or more second port modules 38 to determine a next block 54 from which to read. As an example, consider the linked list described above. A first portion of a packet has been written from first port module 38 to first block 54, a second portion of the packet has been written from first port module 38 to second block 54, and a third and final portion of the packet has been written from first port module 38 to third block 54. An end mark has also been written to third block 54 to indicate that a final portion of the packet has been written to third block 54. A second port module 38 reads from first block 54 and, while second port module 38 is reading from first block 54, uses the pointer in the first entry to determine a next block 54 from which to read. The pointer refers second port module 38 to second block 54, and, when second port module 38 has finished reading from first block 54, second port module 38 reads from second block 54. While second port module 38 is reading from second block 54, second port module 38 uses the pointer in the second entry to determine a next block 54 from which to read. The pointer refers second port module 38 to third block 54, and, when second port module 38 has finished reading from second block 54, second port module 38 reads from third block 54. Second port module 38 reads from third block 54 and, using the end mark in third block 54, determines that a final portion of the packet has been written to third block 54. While a linked list in tag memory 42 cannot be used by more than one first port module 38 to determine a next block 54 to which to write, the linked list can be used by one or more second port modules 38 to determine a next block 54 from which to read.

Different packets can have different destinations, and the order in which packets make their way through stream memory 40 need not be first in, first out (FIFO). As an example, consider a first packet received and written to one or more first blocks 54 before a second packet is received and written to one or more second blocks 54. The second packet could be read from stream memory 40 before the first packet, and second blocks 54 could become available for other write operations before first blocks 54. In particular embodiments, a block 54 of stream memory 40 to which a packet has been written can be made available to a port module 38 for a write operation from port module 38 to block 54 immediately after the packet has been read from block 54 by all port modules 38 that are designated port modules 38 of the packet. A designated port module 38 of a packet includes a port module 38 coupled to a component of system area network 10, downstream from switch core 26, that is a final or intermediate destination of the packet.

In particular embodiments, credits are used to manage write operations. Using credits to manage write operations can facilitate cut-through forwarding by switch core 26, which reduces latency, increases throughput, and reduces memory requirements associated with switch core 26. Using credits to manage write operations can also eliminate head-of-line blocking and provide greater flexibility in the distribution of memory resources among port modules 38 in response to changing load conditions at port modules 38. Also, if credits are used to manage write operations, determinations regarding which port module 38 can write to which block 54 at which time can be made out of the critical path of packets through switch core 26, which increases the throughput and switching speed of switch core 26. A credit corresponds to a block 54 of stream memory 40 and can be used by a port module 38 to write to block 54. A credit can be allocated to a port module 38 from a pool of credits, which is managed by central agent 44. Reference to a credit being allocated to a port module 38 includes a block 54 corresponding to the credit being made available to port module 38 for a write operation from port module 38 to block 54, and vice versa.

A credit in the pool of credits can be allocated to any port module 38 and need not be allocated to any particular port module 38. A port module 38 can use only a credit that is available to port module 38 and cannot use a credit that is available to another port module 38 or that is in the pool of credits. A credit is available to port module 38 if the credit has been allocated to port module 38 and port module 38 has not yet used the credit. A credit that has been allocated to port module 38 is available to port module 38 until port module 38 uses the credit. A credit cannot be allocated to more than one port module 38 at a time, and a credit cannot be available to more than one port module 38 at the same time. In particular embodiments, when a first port module 38 uses a credit to write a packet to a block 54 corresponding to the credit, the credit is returned to the pool of credits immediately after all designated port modules 38 of the packet have read the packet from block 54.

Central agent 44 can allocate credits to port modules 38 from the pool of credits. As an example, central agent 44 can make an initial allocation of a predetermined number of credits to a port module 38. In particular embodiments, central agent 44 can make an initial allocation of credits to port module 38 at the startup of switch core 26 or in response to switch core 26 being reset. As another example, central agent 44 can allocate a credit to a port module 38 to replace another credit that port module 38 has used. In particular embodiments, when port module 38 uses a first credit, port module 38 notifies central agent 44 that port module 38 has used the first credit, and, in response to port module 38 notifying central agent 44 that port module 38 has used the first credit, central agent 44 allocates a second credit to port module 38 to replace the first credit, but only if the number of credits available to port module 38 does not meet or exceed an applicable limit. A limit can be applied to the number of credits that may be available to port module 38. As another example, central agent 44 can allocate one or more credits to port module 38 in response to an increase in a limit applicable to the number of credits that may be available to port module 38. A limit can be applied to the number of credits that may be available to port module 38, and the limit can be changed in response to a change in load conditions at port module 38, one or more other port module 38, or both. In particular embodiments, when the limit has been increased and the number of credits that are available to port module 38 does not meet or exceed the increased limit, central agent 44 can allocate one or more credits to port module 38 so that the number of credits available to port module 38 meets the increased limit.

A linked list in tag memory 42 can be used by central agent 44 to determine a next credit that can be allocated to a port module 38. The elements of the linked list can include entries in tag memory 42 corresponding to blocks 54 that in turn correspond to credits in the pool of credits. As an example, consider four credits in the pool of credits. A first credit corresponds to a first block 54, a second credit corresponds to a second block 54, a third credit corresponds to a third block 54, and a fourth credit corresponds to a fourth block 54. A first entry in tag memory 42 corresponding to first block 54 includes a pointer to second block 54, a second entry in tag memory 42 corresponding to second block 54 includes a pointer to third block 54, and a third entry in tag memory 42 corresponding to third block 54 includes a pointer to fourth block 54. Central agent 44 allocates the first credit to a port module 38 and, while central agent 44 is allocating the first credit to a port module 38, uses the pointer in the first entry to determine a next credit to allocate to a port module 38. The pointer refers central agent 44 to second block 54, and, when central agent 44 has finished allocating the first credit to a port module 38, central agent 44 allocates the second credit to a port module 38. While central agent 44 is allocating the second credit to a port module 38, central agent 44 uses the pointer in the second entry to determine a next credit to allocate to a port module 38. The pointer refers central agent 44 to third block 54, and, when central agent 44 has finished allocating the second credit to a port module 38, central agent allocates the third credit to a port module 38. While central agent 44 is allocating the third credit to a port module 38, central agent 44 uses the pointer in the third entry to determine a next credit to allocate to a port module 38. The pointer refers central agent 44 to fourth block 54, and, when central agent 44 has finished allocating the third credit to a port module 38, central agent 44 allocates the fourth credit to a port module 38.

When a credit corresponding to a block 54 is returned to the pool of credits, an entry in tag memory 42 corresponding to block 54 can be added to the end of the linked list that central agent 44 is using to determine a next credit to allocate to a port module 38. As an example, consider the linked list described above. If the fourth entry is the last element of the linked list, when a fifth credit corresponding to a fifth block 54 is added to the pool of credits, the fourth entry can be modified to include a pointer to a fifth entry in tag memory 42 corresponding to fifth block 54. Because entries in tag memory 42 each correspond to a block 54 of stream memory 40, a pointer that points to a block 54 also points to an entry in tag memory 42.

When a port module 38 receives an incoming packet, port module 38 determines whether enough credits are available to port module 38 to write the packet to stream memory 40. In particular embodiments, if enough credits are available to port module 38 to write the packet to stream memory 40, port module 38 can write the packet to stream memory 40 using one or more credits. In particular embodiments, if enough credits are not available to port module 38 to write the packet to stream memory 40, port module 38 can write the packet to an input buffer and later, when enough credits are available to port module 38 to write the packet to stream memory 40, write the packet to stream memory 40 using one or more credits. As an alternative to port module 38 writing the packet to an input buffer, port module 38 can drop the packet. In particular embodiments, if enough credits are available to port module 38 to write only a portion of the packet to stream memory 40, port module 38 can write to stream memory 40 the portion of the packet that can be written to stream memory 40 using one or more credits and write one or more other portions of the packet to an input buffer. Later, when enough credits are available to port module 38 to write one or more of the other portions of the packet to stream memory 40, port module 38 can write one or more of the other portions of the packet to stream memory 40 using one or more credits. In particular embodiments, delayed cut-through forwarding, like cut-through forwarding, provides one or more advantages (such as reduced latency, reduced memory requirements, and increased throughput) over store-and-forward techniques. Reference to a port module 38 determining whether enough credits are available to port module 38 to write a packet to stream memory 40 includes port module 38 determining whether enough credits are available to port module 38 to write the entire packet to stream memory 40, write only a received portion of the packet to stream memory 40, or write at least one portion of the packet to stream memory 40, where appropriate.

In particular embodiments, the length of an incoming packet cannot be known until the entire packet has been received. In these embodiments, a maximum packet size (according to an applicable set of standards) can be used to determine whether enough credits are available to a port module 38 to write an incoming packet that has been received by port module 38 to stream memory 40. According to a set of standards published by the Institute of Electrical and Electronics Engineers (IEEE), the maximum size of an Ethernet frame is 1500 bytes. According to a de facto set of standards, the maximum size of an Ethernet frame is nine thousand bytes. As an example and not by way of limitation, consider a port module 38 that has received only a portion of an incoming packet. Port module 38 uses a maximum packet size (according to an applicable set of standards) to determine whether enough credits are available to port module 38 to write the entire packet to stream memory 40. Port module 38 can make this determination by comparing the maximum packet size with the number of credits available to port module 38. If enough credits are available to port module 38 to write the entire packet to stream memory 40, port module 38 can write the received portion of the packet to stream memory 40 using one or more credits and write one or more other portions of the packet to stream memory 40 using one or more credits when port module 38 receives the one or more other portions of the packet.

A port module 38 can monitor the number of credits available to port module 38 using a counter. When central agent 44 allocates a credit to port module 38, port module 38 increments the counter by an amount, and, when port module 38 uses a credit, port module 38 decrements the counter by an amount. The current value of the counter reflects the current number of credits available to port module 38, and port module 38 can use the counter to determine whether enough credits are available to port module 38 to write a packet from port module 38 to stream memory 40. Central agent 44 can also monitor the number of credits available to port module 38 using a counter. When central agent 44 allocates a credit to port module 38, central agent 44 increments the counter by an amount, and, when port module 38 notifies central agent 44 that port module 38 has used a credit, central agent 44 decrements the counter by an amount. The current value of the counter reflects the current number of credits available to port module 38, and central agent 44 can use the counter to determine whether to allocate one or more credits to port module 38.

The number of credits that may be available to a port module 38 can be limited, and the limit can be changed in response to changes in load conditions at port module 38, one or more other port module 38, or both. In particular embodiments, the number of credits that may be available to a port module 38 is limited according to a dynamic threshold that is a function of the number of port modules 38 of switch core 26 that are active and the number of credits that are available to port modules 38 for write operations from port modules 38 to stream memory 40. An active port module 38, in particular embodiments, includes a port module 38 that has written a packet to stream memory 40 that has not been read from stream memory 40 to all designated port modules 38 of the packet. A dynamic threshold can include a fraction of the number of credits that are available to port modules 38 calculated using the following formula, in which a equals the number of port modules 38 that are active and ρ is a parameter:

$$\frac{ρ}{1 + ( ρ \times α )}$$

A number of credits can be reserved such that central agent 44 may not allocate a credit to a port module 38 if the number of credits in the pool of credits does not exceed the number of credits that are reserved. Reserving one or more credits can provide a cushion during a transient period associated with a change in the number of port modules 38 that are active. The fraction of credits that are reserved is calculated using the following formula, in which a equals the number of active port modules 38 and ρ is a parameter:

$$\frac{1}{1 + ( ρ \times α )}$$

According to the above formulas, if one port module 38 is active and ρ is two, central agent 44 reserves one third of the credits and may allocate up to two thirds of the credits to port module 38; if two port modules 38 are active and ρ is one, central agent 44 reserves one third of the credits and may allocate up to one third of the credits to each port module 38 that is active; and if twelve port modules 38 are active and ρ is 0.5, central agent 44 reserves two fourteenths of the credits and may allocate up to one fourteenth of the credits to each port module 38 that is active. Although a particular limit is described as being applied to the number of credits that may be available to a port module 38, the present invention contemplates any suitable limit being applied to the number of credits that may be available to port module 38.

When a first port module 38 writes a packet to stream memory 40, first port module 38 can communicate to routing module 46 information from the header of the packet (such as one or more destination addresses) that routing module 46 can use to identify one or more second port modules 38 that are designated port modules 38 of the packet. First port module 38 can also communicate to routing module 46 an address of a first block 54 to which the packet has been written and an offset that together can be used by second port modules 38 to read the packet from stream memory 40. Routing module 46 can identify second port modules 38 using one or more routing tables and the information from the header of the packet and, after identifying second port modules 38, communicate the address of first block 54 and the offset to each second port module 38, which second port module 38 can add to an output queue, as described more fully below.

A port module 38 can include one or more output queues that are used to queue packets that have been written to stream memory 40 for communication out of switch core 26 through port module 38. When a packet is written to stream memory 40, the packet is added to an output queue of each designated port module 38 of the packet. An output queue of a first port module 38 can correspond to a combination of a level of quality of service (QoS) and a second port module 38. As an example, consider a switch core 26 that provides three levels of QoS and includes four port modules 38 including both input logic and output logic. A first port module 38 includes nine output queues: a first output queue corresponding to the first level of QoS and a second port module 38; a second output queue corresponding to the first level of QoS and a third port module 38; a third output queue corresponding to the first level of QoS and a fourth port module 38; a fourth output queue corresponding to the second level of QoS and second port module 38; a fifth output queue corresponding to the second level of QoS and third port module 38; a sixth output queue corresponding to the second level of QoS and fourth port module 38; a seventh output queue corresponding to the third level of QoS and second port module 38; an eighth output queue corresponding to the third level of QoS and third port module 38; and a ninth output queue corresponding to the third level of QoS and fourth port module 38. A packet that has been written to stream memory 40 is added to the first output queue of first port module 38 if (1) the packet has been written to stream memory 40 from second port module 38, (2) first port module 38 is a designated port module 38 of the packet, and (3) the level of QoS of the packet is the first level of QoS. A packet that has been written to stream memory 40 is added to the fifth output queue of first port module 38 if (1) the packet has been written to stream memory 40 from third port module 38, (2) first port module 38 is a designated port module 38 of the packet, and (3) the level of QoS of the packet is the second level of QoS. A packet that has been written to stream memory 40 is added to the ninth output queue of first port module 38 if (1) the packet has been written to stream memory 40 from fourth port module 38, (2) first port module 38 is a designated port module 38 of the packet, and (3) the level of QoS of the packet is the third level of QoS.

Second port module 38 also includes nine output queues: a first output queue corresponding to the first level of QoS and a first port module 38; a second output queue corresponding to the first level of QoS and a third port module 38; a third output queue corresponding to the first level of QoS and a fourth port module 38; a fourth output queue corresponding to the second level of QoS and first port module 38; a fifth output queue corresponding to the second level of QoS and third port module 38; a sixth output queue corresponding to the second level of QoS and fourth port module 38; a seventh output queue corresponding to the third level of QoS and first port module 38; an eighth output queue corresponding to the third level of QoS and third port module 38; and a ninth output queue corresponding to the third level of QoS and fourth port module 38. A packet that has been written to stream memory 40 is added to the first output queue of second port module 38 if (1) the packet has been written to stream memory 40 from first port module 38, (2) second port module 38 is a designated port module 38 of the packet, and (3) the level of QoS of the packet is the first level of QoS. A packet that has been written to stream memory 40 is added to the fifth output queue of second port module 38 if (1) the packet has been written to stream memory 40 from third port module 38, (2) second port module 38 is a designated port module 38 of the packet, and (3) the level of QoS of the packet is the second level of QoS. A packet that has been written to stream memory 40 is added to the ninth output queue of second port module 38 if (1) the packet has been written to stream memory 40 from fourth port module 38, (2) second port module 38 is a designated port module 38 of the packet, and (3) the level of QoS of the packet is the third level of QoS.

Third port module 38 and fourth port module 38 each include output queues similar to the output queues of first port module 38 and the output queues of second port module 38 described above. QoS can encompass rate of transmission, rate of error, or other aspect of the communication of packets through switch core 26, and reference to QoS can include class of service (CoS), where appropriate. Although an output queue of a first port module 38 is described as corresponding to a second port module 38 and a level of QoS, an output queue of a first port module 38 need not necessarily correspond to a second port module 38 and a level of QoS. As an example, in particular embodiments, an output queue of a first port module 38 can correspond to a second port module 38 and not a level of QoS.

An output queue of a port module 38 includes a register of port module 38 and, if there is more than one packet in the output queue, one or more entries in a memory structure of port module 38, as described below. A port module 38 includes a memory structure that can include one or more linked lists that port module 38 can use, along with one or more registers, to determine a next packet to read from stream memory 40. The memory structure includes multiple entries, at least some of which each correspond to a block 54 of stream memory 40. Each block 54 of stream memory 40 has a corresponding entry in the memory structure. An entry in the memory structure can include a pointer to another entry in the memory structure, resulting in a linked list. A port module 38 also includes one or more registers that port module 38 can also use to determine a next packet to read from stream memory 40. A register includes a write pointer, an offset, and a read pointer. The write pointer can point to a first block 54 to which a first packet has been written, the offset can indicate a first word 56 to which the first packet has been written, and the read pointer can point to a first block 54 to which a second packet (which could be the same packet as or a packet other than the first packet) has been written. Because entries in the memory structure each correspond to a block 54 of stream memory 40, a pointer that points to a block 54 also points to an entry in the memory structure.

Port module 38 can use the write pointer to determine a next entry in the memory structure to which to write an offset. Port module 38 can use the offset to determine a word 56 of a block 54 at which to start reading from block 54. Port module 38 can use the read pointer to determine a next packet to read from stream memory 40. Port module 38 can also use the write pointer and the read pointer to determine whether more than one packet is in the output queue. If the write pointer and the read pointer both point to the same block 54, there is only one packet in the output queue. If there is only one packet in the output queue, port module 38 can determine a next packet to read from stream memory 40 and read the next packet from stream memory 40 without accessing the memory structure.

If a first packet is added to the output queue when there are no packets in the output queue, (1) the write pointer in the register is modified to point to a first block 54 to which the first packet has been written, (2) the offset is modified to indicate a first word 56 to which the first packet has been written, and (3) the read pointer is also modified to point to first block 54 to which the first packet has been written. If a second packet is added to the output queue before port module 38 reads the first packet from stream memory 40, (1) the write pointer is modified to point to a first block 54 to which the second packet has been written, (2) the offset is written to a first entry in the memory structure corresponding to first block 54 to which the first packet has been written and then modified to indicate a first word 56 to which the second packet has been written, and (3) a pointer in the first entry is modified to point to first block 54 to which the second packet has been written. The read pointer is left unchanged such that, after the second packet is added to the output queue, the read pointer still points to first block 54 to which the first packet has been written. As described more fully below, the read pointer is changed when port module 38 reads a packet in the output queue from stream memory 40. If a third packet is added to the output queue before port module 38 reads the first packet and the second packet from stream memory 40, (1) the write pointer is modified to point to a first block 54 to which the third packet has been written, (2) the offset is written to a second entry in the memory structure corresponding to first block 54 to which the second packet has been written and modified to indicate a first word 56 to which the third packet has been written, and (3) a pointer in the second entry is modified to point to first block 54 to which the third packet has been written. The read pointer is again left unchanged such that, after the third packet is added to the output queue, the read pointer still points to first block 54 to which the first packet has been written.

Port module 38 can use the output queue to determine a next packet to read from stream memory 40. As an example, consider the output queue described above in which there are three packets. In the register, (1) the write pointer points to first block 54 to which the third packet has been written, (2) the offset indicates first word 56 to which the third packet has been written, and (3) the read pointer points to first block 54 to which the first packet has been written. The first entry in the memory structure includes (1) an offset that indicates first word 56 to which the first packet has been written and (2) a pointer that points to first block 54 to which the second packet has been written. The second entry in the memory structure includes (1) an offset that indicates first word 56 to which the second packet has been written and (2) a pointer that points to first block 54 to which the third packet has been written.

Port module 38 compares the read pointer with the write pointer and determines, from the comparison, that there is more than one packet in the output queue. Port module 38 then uses the read pointer to determine a next packet to read from stream memory 40. The read pointer refers port module 38 to first block 54 of the first packet, and, since there is more than one packet in the output queue, port module 38 accesses the offset in the first entry indicating first word 56 to which the first packet has been written. Port module 38 then reads the first packet from stream memory 40, using the offset in the first entry, starting at first block 54 to which the first packet has been written. If the first packet has been written to more than one block 54, port module 38 can use a linked list in tag memory 42 to read the first packet from memory, as described above.

While port module 38 is reading the first packet from stream memory 40, port module 38 copies the pointer in the first entry to the read pointer, compares the read pointer with the write pointer, and determines, from the comparison, that there is more than one packet in the output queue. Port module 38 then uses the read pointer to determine a next packet to read from stream memory 40. The read pointer refers port module 38 to first block 54 of the second packet, and, since there is more than one packet in the output queue, port module 38 accesses the offset in the second entry indicating first word 56 to which the second packet has been written. When port module 38 has finished reading the first packet from stream memory 40, port module 38 reads the second packet from stream memory 40, using the offset in the second entry, starting at first block 54 to which the second packet has been written. If the second packet has been written to more than one block 54, port module 38 can use a linked list in tag memory 42 to read the second packet from memory, as described above.

While port module 38 is reading the first packet from stream memory 40, port module 38 copies the pointer in the second entry to the read pointer, compares the read pointer with the write pointer, and determines, from the comparison, that there is only one packet in the output queue. Port module 38 then uses the read pointer to determine a next packet to read from stream memory 40. The read pointer refers port module 38 to third block 54 of the second packet, and, since there is only one packet in the output queue, port module 38 accesses the offset in the register indicating first word 56 to which the third packet has been written. When port module 38 has finished reading the second packet from stream memory 40, port module 38 reads the third packet from stream memory 40, using the offset in the register, starting at first block 54 to which the third packet has been written. If the third packet has been written to more than one block 54, port module 38 can use a linked list in tag memory 42 to read the third packet from memory, as described above.

If a port module 38 includes more than one output queue, an algorithm can be used for arbitration among the output queues. Arbitration among multiple output queues can include determining a next output queue to use to determine a next packet to read from stream memory 40. Arbitration among multiple output queues can also include determining how many packets in a first output queue to read from stream memory 40 before using a second output queue to determine a next packet to read from stream memory 40. The present invention contemplates any suitable algorithm for arbitration among multiple output queues. As an example and not by way of limitation, according to an algorithm for arbitration among multiple output queues of a port module 38, port module 38 accesses the output queues in a series of rounds. In a round, port module 38 successively accesses the output queues in a predetermined order and, when port module 38 accesses an output queue, reads one or more packets in the output queue from stream memory 40. The number of packets that port module 38 reads from an output queue in a round can be the same as or different from the number of packets that port module 38 reads from each of one or more other output queues of port module 38 in the same round. In particular embodiments, the number of packets in a first output queue corresponding to a higher level of QoS that can be read in a round from stream memory 40 is greater than the number of packets in a second output queue corresponding to a lower level of QoS that can be read in the same round from stream memory 40. Although a particular criterion is described for removing more packets from one or more output queues than from one or more other output queues, the present invention contemplates any suitable criterion for removing more packets from one or more output queues than from one or more other output queues.

FIG. 6 illustrates a method for performing error detection, in accordance with a particular embodiment of the present invention. As described above, the packet switching performed by a switch embodying aspects of the present invention may include cut-through routing to enhance the overall speed and performance of the switch. Cut through routing enables high speed packet switching by initiating switching of a packet before the entire packet is received by the switch, or switch core.

Cut-through routing complicates the performance of Cyclical Redundancy Checksum (CRC), since the overall size of the packet payload is unkown at the time that switching is initiated. Cyclical redundancy checksum (also known as cyclic redundancy code) is a technique that is employed for error detection in many communication networks. Such codes detect the occurence of transmission errors by adding a few bits, call CRC bits, or checksum bits, to each packet. The CRC is a specific method for calculating the bits that are added to a packet. In many CRC methods, the CRC bits depend upon the total number of bits contained in the packet, or the payload of the packet. When cut-through routing is used, switching of the packets is initiated prior to receiving the entire packet. Therefore, the total number of bits in the payload of the packet may be unkown at the time that switching is initiated. In order to perform error detection in conjunction with a cut-through routing scheme, the present invention employs a limited cyclical redundancy checksum technique. The method is described below with regard to FIG. 6.

The method begins at step 100, where a plurality of packets are received at an input port of a switch. In a particular embodiment of the present invention, the switch may by configured similarly or identical to switch 22 of FIGS. 1 and 2, and may employ a switch core such as switch core 26 of FIG. 4. More particularly, the switch of the present invention may be an ethernet switch. As described above, the switch core may be embodied in a single integrated circuit. However, other types of switches, switch cores, configurations and embodiments are contemplated within the teachings of the present invention.

Packets received at the input port may each include a header, a trailer, and a payload. The payload includes data being transmitted between network elements. Packets vary in size, since each packet may have a unique payload. Therefore, the payload of each packet may vary in both size and content.

Packets that are received at the input port are transmitted to the switch core at step 102, for switching, and appropriate distribution throughout the network. Switching of packets is accomplished at step 104.

Since cut-through routing may be employed by the switch, switching of any particular pack may be initiated before the entire packet is received. Accordingly, any particular packet may be transmitted to the switch core in portions, and/or the switch core may initiate switching upon receipt of only a portion of the packet.

At step 106, the cyclical redundancy checksum bits are calculated. Since the entire packet may not have been received at the switch core, the cyclical redundancy checksum is calculated using tag information associated with the packet, in accordance with the modified cyclical redundancy checksum technique of the present invention.

At step 108, CRC bits are inserted in the portion of the packet being switched, in order to accommodate error detection of the switching operation. Next, at step 1 10, the portion of the packet including the CRC bits is received at an output port of the switch, for appropriate distribution through the network. At step 112, the new packet that includes the CRC bits is transmitted to another component of the network. Finally, at step 114, error detection is accomplished using the CRC bits that were calculated using tag information associated with the packet.

Although the present invention has been described with several embodiments, sundry changes, substitutions, variations, alterations, and modifications may be suggested to one skilled in the art, and it is intended that the invention may encompass all such changes, substitutions, variations, alterations, and modifications falling within the spirit and scope of the appended claims.

1. A method for error detection in a high-speed switching environment, comprising:
receiving, at a switch input port, a plurality of packets, including a first packet having at least first and second portions;
initiating switching of the first portion before the entire second portion is received at the switch port; and
performing an error detection technique on the first packet using tag data associated with the first packet.

2. The method of claim 1, wherein the initiating switching of the first portion is accomplished in accordance with a cut-through forwarding technique.

3. The method of claim 1, wherein the initiating switching of the first portion is accomplished in accordance with a delayed cut-through forwarding technique.

4. The method of claim 1, further comprising looking up a tag ID for association with the first packet.

5. The method of claim 4, further comprising assigning the tag ID to the first packet.

6. The method of claim 1, further comprising receiving the first portion at a switch output port, wherein the error detection is performed at the switch output port.

7. The method of claim 1, wherein the error detection technique is accomplished according to a limited cyclical redundancy checksum technique.

8. The method of claim 7, wherein the cyclical redundancy checksum technique includes recalculating a CRC of the first packet based only upon changes in the tag ID of the first packet.

9. A system for error detection in a high-speed switching environment, comprising:
a first switch input port being operable to receive a plurality of packets, the plurality of packets including a first packet having first and second portions;
a switch core operable to switch the first portion before the entire second portion is received at the first switch input port; and
a detection module being operable to perform an error detection technique on the first packet using tag data associated with the first packet.

10. The system of claim 9, wherein the first switch input port is further operable to lookup a tag ID for association with the first packet.

11. The system of claim 10, wherein the first switch input port is further operable to assign the tag ID to the first packet.

12. The system of claim 9, further comprising a switch output port being operable to receive the first portion of the first packet.

13. The system of claim 12, wherein the switch output port comprises the error detection module.

14. The system of claim 13, wherein the error detection technique is accomplished according to a limited cyclical redundancy checksum technique.

15. The system of claim 14, wherein the cyclical redundancy checksum technique includes recalculating a CRC of the first packet based only upon changes in the tag ID of the first packet.

16. The system of claim 15, wherein the first portion is switched in accordance with a cut-through forwarding technique.

17. The system of claim 15, wherein the first portion is switched in accordance with a delayed cut-through forwarding technique.

18. A system for performing error detection in a high-speed switching environment, the system comprising:
one or more memory structures;
a plurality of input structures that are each operable to receive a packet communicated from a component of a communications network and write the received packet to one or more of the one or more memory structures;
a first switching structure coupling the plurality of input structures to the one or more memory structures such that each of the plurality of input structures are operable to write to each of the one or more memory structures;
a plurality of output structures that are each operable to read a packet from one or more of the one or more memory structures for communication to a component of the communications network;
a second switching structure coupling the plurality of output structures to the one or more memory structures such that each of the plurality of output structures are operable to read from each of the one or more memory structures, an output structure being operable to read a first portion of one of the packets from one or more of the one or more memory units for communication to a first component of the communications network before an input structure has received a second portion of the one of the packets communicated from a second component of the communications network; and
a detection module being operable to perform an error detection technique on the first packet using tag data associated with the first packet.

19. The system of claim 18, wherein the memory structures are operable to store tag IDs for association with the packets.

20. The system of claim 19, wherein the error detection technique is accomplished according to a limited cyclical redundancy checksum technique.
